(19) United States
(12) Patent Application Publication
(10) Pub. No.: US 2002/0041339 A1
(43) Pub. Date: Apr. 11, 2002

(54) Graphical representation of motion in still video images

(76) Inventor: Klaus Diepold, Siegertsbrunn (DE)

Correspondence Address: VENABLE, BAETJER, HOWARD AND CIVILETTI, LLP, P.O. BOX 34385, WASHINGTON, DC, 20043-9998, US

(21) Appl. No.: 09/971,650

(22) Filed: Oct. 9, 2001

Related U.S. Application Data
(60) Provisional application No. 60/238,459, filed on Oct. 10, 2000.

(51) Int. Cl. H04N 5/14

(52) U.S. Cl. 348/700

(57) ABSTRACT

In a system for processing video to represent motion in still images, the motion of objects in the video is detected by a video processor which generates dense motion vector fields to identify moving objects in a selected video frame. The video processor adds speedlines to the selected frame, contour repetition to the selected frame, or image repetition to the selected frame to represent the motion of the objects in the selected frame.

This application claims the benefit of provisional application Serial No. 60/238,459, filed Oct. 10, 2000.

This invention relates to depicting speed in still pictures and more particularly to an improved method and apparatus for modifying an individual frame of a motion picture to depict the occurrence of motion or speed in the motion picture frame.

### BACKGROUND OF THE INVENTION

When an individual frame of a motion picture is displayed, objects which are in the motion picture are shown as fixed and the fact that the individual objects shown in the frame are moving is not indicated. It has been proposed to indicate the motion of moving objects in a still picture by blurring the images of objects in motion. The blurred object images are recognized as representing motion since moving objects shown in photographs will be blurred if the shutter speed or film speed is inadequate to stop the motion of the moving objects. This method is considered unsatisfactory because the detailed depiction of the blurred objects is lost. Since the moving objects in a motion picture frame are often the subjects of most interest, depiction of blurred images of these objects is undesirable.

### SUMMARY OF THE INVENTION

In accordance with the invention, the motion of moving objects in a frame of a motion picture shown as a still depiction is represented in the same way that motion is represented in newspaper comics. In accordance with one embodiment, motion is depicted by speedlines, which are lines extending backwards from prominent points on the moving objects in the direction from which the object may be moving. Alternatively, the motion of an object may be depicted by an arrow added to the frame depiction. In accordance with other embodiments the motion is depicted by image or contour repetition. In accordance with these methods the motion of the objects is represented by repeating the image or redrawing the contours of the moving objects several times at spaced intervals behind the moving object along the path in which the object is moving.

In accordance with the invention the motion of objects in the motion picture is detected by generating dense motion vector fields representing the motion of image elements from frame to frame in the motion picture. Image elements are pixel sized components of objects depicted in the motion picture and move with the objects as they change position from frame to frame in successive frames of the motion picture. The dense motion vector fields will indicate the motion of each image element between successive frames of the motion pictures. In accordance with the invention a key frame from the motion picture is selected to be displayed. The dense motion vector field representing the motion of image elements from the preceding frame to the selected key frame or from the selected key frame to the succeeding frame, or both, are generated. From these dense motion vector fields the moving objects in the selected frame are detected and the moving objects are highlighted. Once the moving objects have been highlighted, the operator selects from the highlighted objects those objects for which he wants to depict motion in the key frame. Graphics are then added to the key frame to depict motion of the selected objects by speedlines, by arrows, or by image or contour repetition. After the motion graphics have been added to the key frame, the key frame is displayed to the user for his approval. Upon approval, the key frame with the added graphics is stored and the operation is complete.

### BRIEF DESCRIPTION OF THE DRAWINGS

FIG. 1 is a block diagram of the apparatus of the invention.

FIG. 2 illustrates a still frame in which motion of the object is depicted by speedlines.

FIG. 3 illustrates a still frame in which the motion of objects is depicted by the combined use of contour repetition and speedlines.

FIG. 4 illustrates a set of three images showing the result of the operation of the present invention producing repetition of an image of the trailing portion of a moving object to represent motion.

FIG. 5 illustrates the process of overlaying images to produce image repetition to represent motion.

FIG. 6 is a flowchart illustrating the method of the invention.

### DETAILED DESCRIPTION OF THE INVENTION

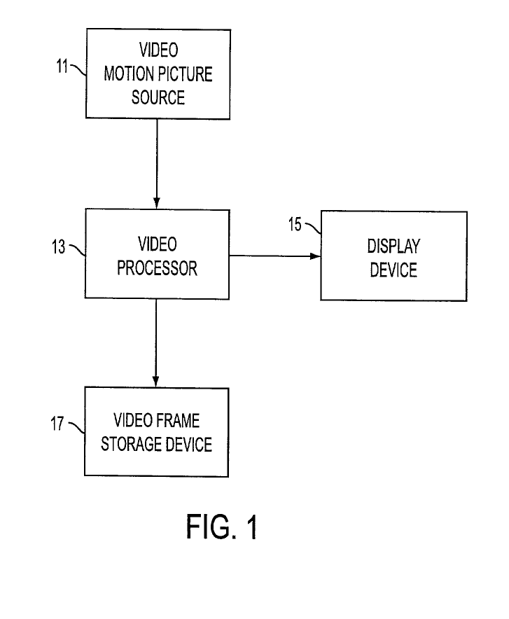

As shown in FIG. 1, the system of the invention comprises a video motion picture source 11 and a video processor 13 connected to receive video motion pictures from the source 11. The video processor 13 is operable to select a key frame from a received motion picture and modify the key frame to graphically represent motion in the key frame. The modified key frame may be displayed as a still picture by a display device 15 or the modified key frame maybe stored in a video frame storage device 17 for display later by the display device 15 under control of the processor 13.

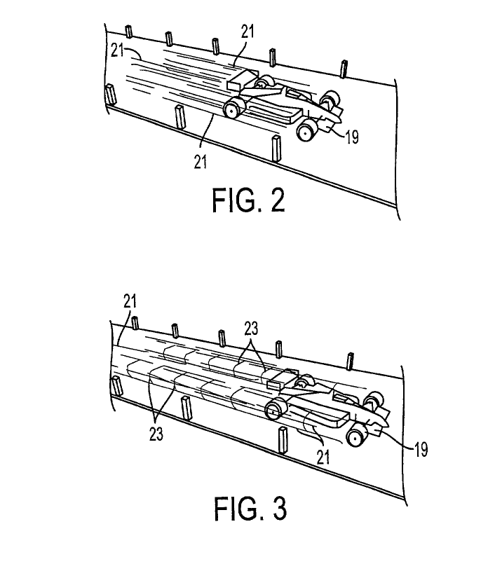

The graphical representation of motion may be by way of speedlines such as illustrated in FIG. 2 in which the motion of a racing car 19 is represented by speedlines 21. This technique of graphically representing motion is a well known graphic device to represent speed in individual pictures and is frequently found in newspaper comics or comic books. Instead of or in addition to representing object motion by speedlines, the video processor may modify the key frame to represent the motion of objects by adding contour repetition to the key frame. FIG. 3 shows a picture in which the speed of the race car 19 is represented by both speedlines 21 and by contour repetition 23. When the motion is represented by contour repetition as shown in FIG. 3, the earlier positions of a moving object are drawn with less detail and slightly faded whereas the current state of the object is presented in full detail.

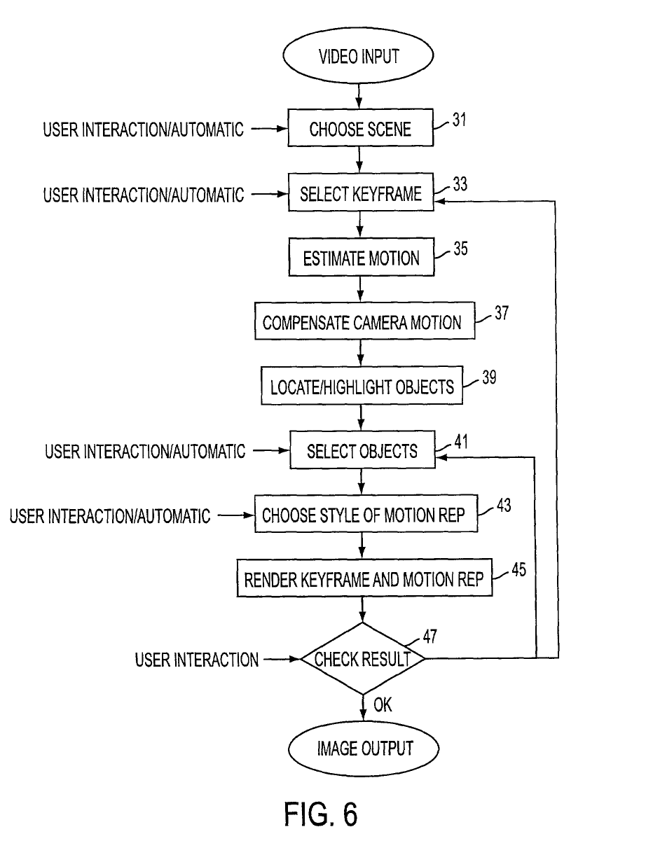

The process of the invention carried out by the video processor 13 is depicted in the flowchart shown in FIG. 6. As shown in this Figure, in step 31, a scene is selected from a motion picture video received by the processor 13 from the source 11. A scene is defined as a sequence of frames of a video between scene cuts, at which an abrupt change in what is being depicted in the video occurs. The scene cuts maybe detected by the process described in the co-pending application Ser. No. 60/278,443, entitled Estimation and Compensation of Brightness Changes of Optical Flow, filed Mar. 26, 2001. The system described in this application analyzes brightness changes from frame to frame the brightness changes are classified into different classifications one of which is referred to as a scene shift, which is another term for scene cut. This co-pending application is hereby incorporated by reference. Instead of selecting the scene automatically, the frames making up the scene may be selected directly by the user, or the selection may be a combination of both automatic selection and interaction with the user. For example, the software may select a scene and the selected scene may then be adopted, overruled, or edited by the user. Following the selection of the scene in step 31, a key frame of the selected scene is selected in step 33. The key frame maybe selected automatically by the software or the key frame maybe selected manually by user interaction, or the selection maybe a semi-automatic selection combining both automatic selection and manual selection. For example, the process may automatically propose a frame to be the key frame, which the user may adopt or reject. In the latter case, the user will manually select a different key frame from the selected scene.

The selected key frame along with either the preceding or the succeeding frame or both are fed to the motion estimator routine 35 which extracts motion information with respect to the selected key frame. The motion information in the preferred embodiment represents the motion occurring in the motion picture at the key frame. The motion information may be in the form of one or more dense motion vector fields and may be detected as described in copending application Ser. No. 09/593,521 entitled Estimation of Optical Flow, filed Jun. 14, 2000. This application is hereby incorporated by reference. The dense motion vector fields will represent the motion of pixel sized image elements from frame to frame. In the preferred embodiment, one dense motion vector field will represent the change in position of image elements from the key frame to the succeeding frame. A second dense motion vector field will represent the change in position of image elements from the preceding frame to the key frame. The motion vectors may represent the motion of objects within the depicted scene or they may represent the motion of the camera, such as when the camera is panned or zoomed in or out. The camera motion is detected from the dense motion vector fields by known techniques. This detection may be for example, detecting that the vectors of a dense motion vector field distributed over the entire frame are predominantly parallel and in the same direction indicating a video camera panning in the opposite direction of the parallel vectors and with a panning velocity indicated by the magnitude of the parallel dense motion vectors. Camera zooming will be indicated in a similar manner by radial vectors pointing inwardly or outwardly.

Following the camera motion detection, the dense motion vector fields are adjusted in step 37 in accordance with the camera motion, so that the adjusted dense motion vector fields represent only the motion of moving objects at the key frame in the depicted scene. To make this adjustment of dense motion vector field, a dense motion vector field representing only camera motion for all of the image elements is generated and then this dense motion vector field is subtracted from the detected dense motion vector field to leave a dense motion vector field cleaned of camera motion and representing only the motion of moving objects.

From the clean dense motion vector fields, the pixels in the key frame corresponding to moving objects are detected and highlighted in step 39. Each of the two detected motion vector fields will represent motion at the key frame, one representing motion to the key frame and one representing motion from the key frame. The moving objects may highlighted in accordance with either clean motion vector field. In the preferred embodiment, the two vector fields are averaged and the average vector field is used to detect and highlight the moving object. The process of detecting and highlighting the pixels of the moving object may be carried out as disclosed in copending application Ser. No. 09/658,947 entitled Special Effects Video in Response to Depicted Motion, filed Sep. 11, 2000. Alternatively, just the edges of the moving objects may be highlighted as described in the application Ser. No. 09/690,171 entitled Adjusting the Edges of Moving Objects in a Motion Picture, filed Oct. 20, 2000. After the moving objects have been highlighted, the object or objects for which graphics motion representation will be applied in the key frame are selected in step 41. Initially all of the highlighted objects will be automatically selected. The user may overrule the automatic selection means of manual interaction and select those highlighted objects for which graphics representation of motion is to be applied. The result of selecting the moving objects in step 26 is an object mask or masks for the moving object or objects.

Following step 41, the program in step 43 prompts the user to select what style shall be used for the graphic motion representation. The choices for the user may be speedlines, contour repetition, image repetition, a combination of both speedlines or contour repetition, or other types of motion representation such as arrows. At this time, the user will also select and adjust parameters for the generation of the graphic motion representation, such as the line type and line density of the speedlines or contour repetition.

The concept of speedlines, contour repetition, and image repetition to represent motion was invented by artists and their generation requires some heuristics about where and how to draw them. In general, speedlines and contour repetition extend in the opposite direction the movement of which they represent; originate at characteristic points of the moving objects; embrace the minimum and maximum extent of the moving object; are more or less equally sized, shaped, and directed without intersecting each other; and are uniformly but not too regularly distributed. In step 45, the processor to generate the speedlines, will select key points as candidates for the origins or starting points for the speedlines. The selected key points will include at least the extreme points of the mask of the moving objects. The algorithm divides the mask into a number of strips wherein each strip can hold one speedline. If a strip contains no key point, additional points will be generated on the object's outline. When the speedlines are generated, the speedlines are drawn with an offset so that they are spaced from their points of origin on the object outline. The speedlines are drawn using a line style which simulates hand drawn pen strokes and will include irregular occurring gaps along the length of each individual speedline. The speedline output of the graphic motion renderer in step 45 will consist of an image of a key frame which has been overlaid with the speedlines. Nearly all the speedline parameters can be computed based on the clean dense motion vector field. The length, distribution, number and characteristics of the speedlines are determined by the video processor by applying selected heuristic rules for artistic expression.

To generate contour repetition, the contour of the moving object to be repeated is determined by the processor from the trailing edge of the mask of the moving object. The contour lines are then repetitively inserted distributed rearwardly from the trailing edge of the object with the contour lines becoming slightly more faded or lighter as their distance from the trailing of the moving object increases. In addition, as an option, the contour lines may become progressively smaller as the distance from the trailing edge of the moving object increases.

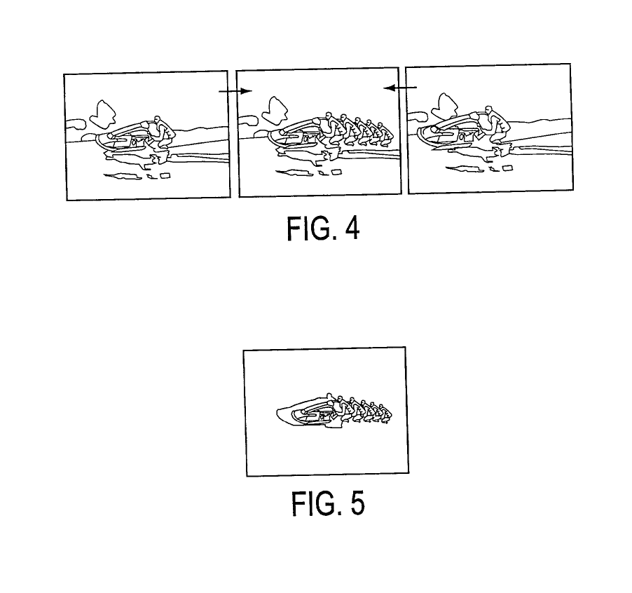

The FIGS. 4 and 5 show how object repetition is used to represent motion. In these figures, the motion is represented by repeating an image of a portion of the moving object at the trailing edge of the moving object. In this process, to generate this form of graphic representation of motion, a series of frames preceding the key frame are selected to be overlayed in the graphic representation. These selected frames may be actual frames from the motion picture or they may be generated by interpolation between the actual frames to obtain the images of the moving object at the desired intervals. The interpolated frames are preferably generated by means of dense motion vector fields as described in co-pending application Ser. No. 09/495,988 filed Dec. 14, 1999, entitled “Motion Picture Enhancing System.” This co-pending application is hereby incorporated by reference. The process of producing the graphic representation is carried out by using masks of the moving object generated in step 21 to extract out the image of the moving object from each of the motion picture frames selected for overlay. The moving object in the earliest frame is overlayed on the key frame with the pixels of the overlayed moving object image replacing the corresponding pixels in the key frame. The image of the moving object of the next earliest frame is overlayed on the modified key frame and the process is repeated with each selected frame. The final step of the process is to overlay the image of the moving object extracted from the key frame on the key frame modified with the overlays from the earlier selected frames. FIG. 5 illustrates the process showing four previous frames already having been overlayed on the key frame and before the image of the moving object in the key frame has been added.

After the object motion graphic representation has been generated, the processor will display the key frame with the added graphics representing motion in step 47 on the display device 15 to the user for approval and editing. If and when the resulting rendition is approved by the user, the image with the graphic representation of motion is stored in the still frame storage 19 and the process is completed. If the user does not approve the result, the user can return the process to step 33 to repeat the process from the point of selecting a new key frame. Alternatively, at the user's option, the process may be returned to step 41 to select the moving objects to which the graphic representation will be applied to and repeat the process from step 41.

The system as described above provides the user with a semi-automated system for facilitating the rendering of graphical representation of motion wherein the user is given options to select the characteristics and style of the graphic representation which is rendered. The use of the automated features of the invention greatly facilitates the modification of the still frames to add graphic representation of motion.

The above description is of a preferred embodiment of the invention and modification may be made thereto without departing from the spirit and scope of the invention which is defined in depending claims.

What is claimed is:

1. A method of producing a graphical representation of motion in a still picture comprising selecting a key frame from a sequence of video frames representing object motion, detecting the motion of at least one object represented by said sequence of video frames, and rendering a graphic representation of the motion of said object superimposed upon said key frame.

2. A method as recited in claim 1 wherein in said graphic motion representation is in accordance with the object motion detected.

3. A method as recited in claim 1 wherein said graphic motion representation comprises speedlines.

4. A method as recited in claim 1 wherein said graphic representation of motion comprises contour repetition.

5. A method as recited in claim 1 wherein said graphic representation comprises image repetition.

6. A method as recited in claim 1 wherein object motion is represented by the change in position of image elements between said key frame and an adjacent frame in said sequence.

7. A method as recited in claim 6 wherein the object motion detection results in a generation of a dense motion vector field representing the motion of image elements at said key frame.

8. A method as recited in claim 7 wherein said dense motion field is modified to eliminate the effect of camera motion wherein the resulting modified dense motion vector field represents only object motion at said key frame.

9. A method as recited in claim 1 wherein the object motion is detected at said key frame by detecting the overall change in position in components in the depicted scene between said key frame and at least one adjacent frame, detecting the change in position of said components due to camera motion between said key frame and said at least one adjacent frame, and subtracting said change in position due to camera motion from said overall change in position to determine the object motion at said key frame.

10. A method as recited in claim 1 further comprising highlighting the objects detected to be in motion at said key frame and selecting one or more of the highlighted objects for rendering a graphic representation of the motion of the selected highlighted objects.

11. An apparatus for producing a still picture with graphical representation of object motion comprising a source of a video comprising a sequence of video frames representing object motion, a video data processor connected to receive said video frames and operable to detect from said video frames the motion of objects represented by said video at a key frame of said video and to overlay on said key frame a graphical representation of the object motion detected.

12. An apparatus as recited in claim 11 wherein said graphical representation comprises speedlines.

13. An apparatus as recited in claim 11 wherein said graphical representation comprises repeated contour lines.

14. An apparatus as recited in claim 11 wherein said graphical representation is image repetition.

15. An apparatus as recited in claim 11 wherein said graphical representation is in accordance with detected motion of said objects at said key frame.

16. An apparatus as recited in claim 11 wherein said video processor is operable to detect the overall change in position of components in the depicted scene from frame to frame, to detect the change in position of components from frame to frame in the depicted scene due to camera motion, and to subtract the detected camera motion from said overall motion to determine the object motion at said key frame.
